(19) United States
(12) Patent Application Publication
(10) Pub. No.: US 2002/0048623 A1
(43) Pub. Date: Apr. 25, 2002

(54) Composite meat product and method for the manufacture thereof

(76) Inventors: Konrad Baarda, Calgary (CA); Henry Fehr, Calgary (CA)

Correspondence Address: Ms. Roseann B. Caldwell, BENNETT JONES LLP, 4500 Bankers Hall East, 855 - 2nd Street SW, Calgary, AB, T2P 4K7, CA

(21) Appl. No.: 09/780,670

(22) Filed: Feb. 12, 2001

(30) Foreign Application Priority Data
Sep. 6, 2000 (CA) 2,318,332,

(51) Int. Cl. A23B 4/00

(52) U.S. Cl. 426/272; 426/641; 426/332

(57) ABSTRACT

Disclosed is a composite meat product with added fat wherein the meat and fat are bonded together with a cold set binder. As desired, the product has a natural marbled fat appearance and/or a natural fat cap. The product is bonded without the need for heat and the integrity of the bonding is maintained upon freezing, thawing, or cooking of the product. The product has the appearance, handling properties and bite of the full muscle cut of meat. The invention further discloses a method for the manufacture of a composite meat product with added fat in which meat pieces and fat are bound to each other with a cold set binder. To provide marbled fat, meat pieces and powdered fat are mixed together, followed by mixing with a cold set binder and forming of the product. Prior maceration of the meat pieces provides for a uniform distribution of marbled fat throughout the meat product by inclusion of powdered fat within cuts made in the macerated meat. To provide a fat cap, a natural fat cap is bonded to the surface of a formed meat core.

### FIELD OF THE INVENTION

The invention relates to a composite meat product and in particular to a raw or cooked composite meat product that has the appearance, handling properties and bite of a full muscle cut of meat. The invention also relates to a method for manufacturing a composite meat product that has the appearance, handling properties and bite of a full muscle cut of meat.

### BACKGROUND OF THE INVENTION

Numerous attempts have been made in the meat industry to provide composite meat products comprised of defatted pieces of meat bonded together with a meat bonding material in an arbitrary shape.

In some cases, the meat pieces are bound together by myosin protein that is extracted from the meat itself upon treatment with salt and/or mechanical agitation. The bonding process, however, requires that the meat be cooked or heated to set the bonding. Consequently, the meat product cannot be handled in the raw, unfrozen state. More recently, various “cold set” binders have been used that provide for the bonding of meat pieces together without the need for cooking. The resulting bonding is sufficiently strong and stable such that the meat product may be handled as a raw full muscle product.

It is often desired to add fat to the meat product to increase the juiciness and flavor of the product, particularly when lower grades of meat having a very low fat content are used. Fat may also be added to create a product that has a marbled appearance or a fat cap, as is found in higher or top grades of beef.

While a number of methods have been developed for the addition of fat to composite meat products, these are all based on the activity of myosin for bonding such that the product must be cooked for bonding to occur. In addition, prior art attempts to provide a natural fat appearance, along with the appearance of a full muscle meat, have been unsatisfactory.

Prior art attempts to provide a natural marbled fat appearance include U.S. Pat. No. 4,377,597, which discloses the addition of a mixture of chopped meat and fat to the meat product and U.S. Pat. No. 4,544,560, which discloses the addition of fat particles, trimmings or emulsion to the meat. In both cases, the product does not have a natural marbled appearance, but rather a processed appearance.

U.S. Pat. No. 4,377,598 also discloses the formation of a fat cap using a fat emulsion, however, this product has an obvious fabricated appearance. While U.S. Pat. No. 3,911,154 discloses the addition of a natural fat cap that has been previously removed from a cut of meat, this method requires that the added fat cap be trimmed so as to retain a layer of meat on one side for bonding to a formed meat core. Standard butchering practices, however, typically involve the removal of excess meat from fat caps such that fat caps retaining a consistent layer of meat on one side may not always be readily available.

### SUMMARY OF THE INVENTION

The invention provides for a composite meat product with added fat that simulates the characteristics and nature of a full muscle product and a method for its manufacture using a cold set binder. The product includes pieces of meat connected by bonds that are strong and stable and form without high temperatures, therefore the final product can be provided to and handled by the consumer in the raw state. The product may also be frozen or cooked without loss of the integrity of the bonding. Overall, the product has the appearance, handling properties and bite of a raw or cooked full muscle product.

Accordingly, a broad aspect of the invention provides a method for producing a composite meat product comprising the steps of: a) providing raw meat pieces; b) mixing powdered fat with the meat pieces to produce a first mixture; c) mixing a cold set binder with the first mixture to produce a second mixture; d) forming the second mixture into a desired shape; and e) maintaining the desired shape at least until adjoining meat pieces and fat become bonded together.

By mixing of the solid powdered fat with the meat pieces, fat is interspersed around the surface of the meat pieces to provide a marbled fat appearance of the final product. A more natural marbled appearance can be produced, however, by making cuts in the meat, as with a macerator, prior to adding the powdered fat such that the fat distributes within the cuts. In this way, the marbled fat is distributed throughout the entire meat product. Maceration also has the added benefit of tenderizing tougher muscles and producing a uniform bite and consistency between the varying muscles used in the composite meat product. This provides the option of using numerous muscles of the beef chuck that would traditionally be sold as separate cuts due to their varying degree of tenderness to toughness. These varying muscles can now be used to form a consistently tender composite meat product.

To further simulate a natural cut of meat, at least one unitary piece of fat can be added to a meat core prepared containing granulated fat.

### BRIEF DESCRIPTION OF THE DRAWINGS

The invention will now be described, by way of example only, reference being made to the accompanying drawings in which:

FIG. 1 is a perspective view of a meat product according to the present invention;

FIG. 2 is a sectional view along line 2-2 of FIG. 1 with the fat cap removed.

FIG. 3 is a block diagram of the steps for manufacturing a composite meat product according to the present invention.

### DETAILED DESCRIPTION OF THE INVENTION

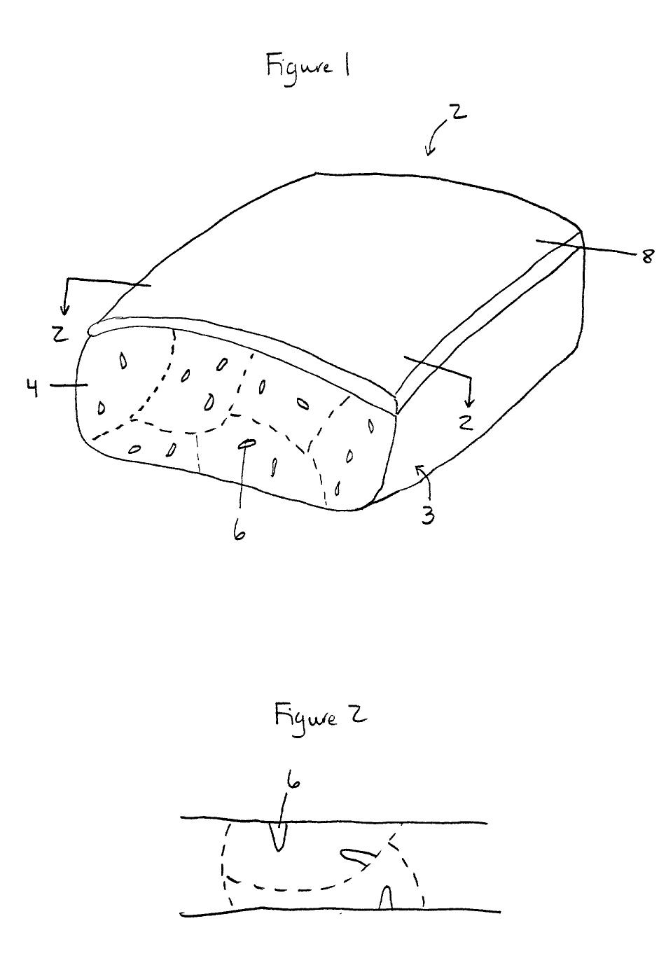

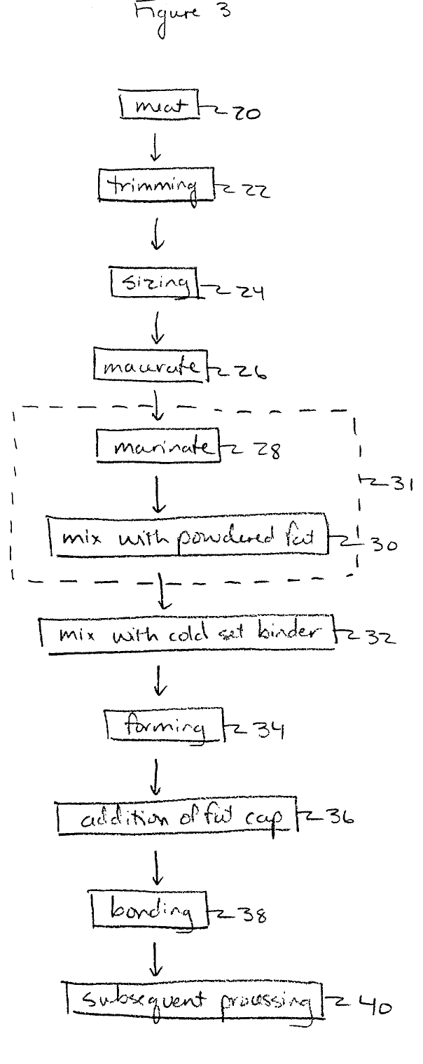

An exemplary embodiment of a composite meat product made according to the present invention is illustrated in FIGS. 1 and 2. The product 2 resembles a high quality roast or steak product that is characterized by a meat core 3 and a fat cap portion 8. The meat core 3 consists of meat pieces 4 and marbled fat 6, where the marbled fat is randomly distributed throughout the meat core. For illustration purposes, the dashed line indicates individual meat pieces 4; however, in the actual product the seams between the meat pieces 4 are virtually undetectable.

A cold set binder holds the product together such that strong stable bonding of meat-to-meat, meat-to-fat, and fat-to-fat occurs in the absence of cooking. The integrity of this bonding is maintained if the product is raw, after cooking, or upon freezing and thawing of the raw meat.

Referring now to FIG. 3, an exemplary embodiment of the steps taken in manufacturing a composite meat product according to the present invention is illustrated. It will be appreciated that depending on the desired end product the combination of particular steps can be varied.

Raw meat 20 is first trimmed 22 of excessive fat and sinew to allow for a uniform appearance, texture and bite throughout the final product. It is advantageous to use fresh meat for optimum bonding results, however, previously tempered or frozen meat can also be used. Any type of meat can be used in the present invention, including, but not limited to, beef, pork, sheep, lamb, poultry, venison, fish and seafood. It would be appreciated that, although fat can be added to fish and seafood, this is not a usual industry practice as such a product is not sought after commercially. In addition, any combination of cuts of meat and/or kinds of meat can be used in a single composite meat product.

To facilitate further processing steps, the meat is sized 24 by cutting into pieces 4 with dimensions generally ranging from 1″×1″×½″ to 6″×6″×4″, with a preferred size of about 4″×2″×1″. The particular size of the meat pieces 4 will depend on the size of the starting meat and the suitability of the starting meat or meat pieces for the equipment used in producing the meat product.

The following steps of maceration 26 and marination 28 are advantageously, but not necessarily, carried out to maximize the overall appeal of the final product, as discussed below.

Maceration 26 is commonly used in the industry. According to the present invention, the process of maceration 26 requires that the muscle be cut so as to create openings in the muscle tissue. One result of maceration 26 is tenderization of the meat by cutting of the muscle grain or fibers into shorter lengths. This provides for a meat product with uniform consistency, bite and appearance between various muscles. It also allows the use of tough muscle pieces such that less expensive cuts of meat can be used to simulate higher end products. As will be discussed in more detail below, a second result of the maceration 26 step of the present invention is that powdered fat can be distributed within the openings in the meat pieces 4 created by maceration. Thereby, a meat product is produced with a natural marbled appearance. Without such openings, the fat powder will distribute only between the seams of the meat, resulting in a less natural appearance.

While various methods for maceration as are known in the art may be used, it is preferable to use a meat and poultry macerator having two or more sets of knife roller blade assemblies through which the meat pieces are passed. In addition, the blade assemblies should be adjustable to allow for a variable depth of cut. While equipment that produces cuts that penetrate through the meat, such as a needle or blade tenderizer, or which result in extensive tearing of the meat, such as a kidney plate with a two blade knife, can also be used, these produce a less satisfactory product than the preferred macerator.

Marination 28 is a well-known procedure in the industry for increasing the moisture content of meat to increase its juiciness. Marinades typically consist of an aqueous solution containing phosphate and salt, where the phosphate and salt improve the moisture retention capacity of the meat. For use in the present invention, suitable phosphates include sodium tripolyphosphate, dibasic phosphate, and hexametaphosphate in amounts of 0.1-0.6% w/w and suitable salts include NaCl and KCl in amounts of 0.1-1.0% w/w. It is preferred to use 0.45% w/w sodium tripolyphosphate and 0.8% w/w NaCl such that natural meat flavor is maintained, while providing the benefit of increased juiciness. It is also desired to include sugar such as dextrose, glucose, and corn syrup solids in amounts of 0.05-0.6% to mask the saltiness of the meat, as well as an antioxidant such as ascorbic acid, erythrobate, rosemary or sodium bicarbonate. In addition, it is observed that optimal results are obtained when the marinade solution is at about 0° C. when added to the meat.

A controlled amount of moisture pick-up is obtained by adding a specific amount of liquid and vacuum tumbling until the liquid is completely absorbed by the meat. Moisture pick-up of 5-40% w/w based upon the green (trimmed, not marinated) weight of the meat can be used, but a pick-up of 15% w/w is preferred as it provides maximum juiciness while maintaining the texture of a full muscle meat cut. It is important in the present invention to avoid lengthy tumbling times or aggressive tumbling procedures that would result in the extraction of the myosin protein, as observed by the formation of a creamy, tacky coating on the surface of the meat. The formation of a myosin coating is undesirable because it may interfere with the bonding properties of the cold set binder by creating a protein barrier between the binder and the meat or fat tissue. A myosin coating also changes the natural texture of the meat. Suitable tumbling conditions will vary depending on the type of meat, type of tumbler, and tumbling parameters. Tumbling times of 10-20 min can generally be used without substantial myosin extraction.

Next, powdered fat is added to the meat and the meat and fat are thoroughly mixed together 30. This step provides for a marbled fat appearance, particularly where the powdered fat is distributed within the openings of the meat pieces 4 that have been treated by maceration.

Powdered fat can be made by chopping frozen fat trimmings with a silent cutter or other suitable means while maintaining the fat in the frozen state, for example, by adding dry ice pellets or CO₂ snow to the fat. Approximately ½-1 lb of dry ice per 1 lb of fat is generally used. The chopping is done at high speed until a particle size similar to that of flour is obtained. Larger particles will result in an unnatural granular appearance of the marbled fat and an uneven distribution of the powdered fat throughout the meat. As an option, prior to chopping, the frozen trimmings can be run through a coarse plate having holes of about 1″ or larger. Any source of fat trimmings can be used for making powdered fat, however, it should be as fresh as possible to minimize microbial contamination. It is not necessary to remove all extraneous meat from the fat trimmings prior to use for making powdered fat. The powdered fat is stored frozen until immediately before use. It is not desirable, at any point in the processing, storage or use of the powdered fat to allow the fat to melt, as this adversely affects the taste and texture of the fat.

The frozen powdered fat may be added directly to the meat or it may be first dispersed in an aqueous solution so as to form a homogenous slurry that is then added to the meat. The slurry can be made using, for example, a commercial type marinade blender. The slurry should be used immediately after mixing to avoid separation of the fat and liquid phases prior to adding the slurry to the meat. The slurry can be mixed with the meat in a variety of ways, such as, for example, with a paddle mixer or a vacuum tumbler. It is preferred to use a vacuum tumbler as this provides for better absorption of the liquid and distribution of fat into the openings of macerated meat.

If it is desired to marinate 28 the meat, the powdered fat can be added to the marinade solution such that steps 28 and 30 are combined into a single step 31. For optimal results, the marinade should be cooled to a temperature of approximately 0° C. prior to adding the powdered fat.

For optimal flavor, it is preferred to use 5-12% w/w powdered fat based on meat weight. The particular amount of fat used will depend on the amount of fat in the meat pieces and the desired fat content of the meat product. For example, to produce a product resembling a high grade cut of beef from lower grade meat pieces, greater amounts of powdered fat should be used. On the other hand, in some instances, it is only desired to achieve an increase in flavor and juiciness without a noticeable marbled appearance, such as in poultry products. In that case, lower amounts of powdered fat will be used.

After the meat and powdered fat have been thoroughly mixed, a cold set binder 32 is added to the mixture. A variety of cold set binders can be used. These include, but are not limited to those that are based on fibrinogen and thrombin (e.g., Fibrimex™ (Harimex Inc., Canada)) and those that are based on transglutaminase (e.g., Activa (Ajinomoto USA Inc., Japan)). Some preparation can be required in the use of these binders such as thawing or blending of ingredients.

In the present invention, the preferred binder is Fibrimex™, in which thrombin cleaves fibrinogen to form fibrin molecules that spontaneously aggregate into fibrin networks. The enzyme transglutaminase present in the Fibrimex™ system cross-links fibrin molecules to each other and to protein molecules in the meat and fat thereby forming strong bonds which act to join meat pieces to meat pieces, meat pieces to fat, and fat to fat.

The transglutaminase-based cold set binders create covalent bonds between proteins. Preferably, it is used in a water solution rather than adding a transglutaminase powder directly to the meat, since the powder can accumulate between adjacent meat pieces.

In general, the conditions previously established for bonding meat-only products using cold set binders can be used without modification for bonding the fat-containing meat product of the present invention. Such conditions include the amount of binder used and the time, pH and temperature of the mixing and bonding steps. These conditions are set out in the information materials available for distribution with the cold set binder products.

The binder is mixed 32 with the meat by a variety of ways, such as with a paddle mixer, ribbon mixer, in-line mixer, or by tumbling without vacuum. Preferably, a ribbon mixer is used. Once the binder is added to the meat, the mixture should be mixed substantially continuously until an even topical coating of the binder over the meat parts is achieved.

After the meat is coated with the cold set binder, portions of the meat are stuffed into containers, such as casings or molds, to form 34 a meat product of a desired shape. While it is often desired to form 34 the meat product into a shape resembling a natural cut of meat, this is not required. The formed product is then allowed to set for a period of time such as to permit bonding 38 to take place.

The meat may be portioned into containers manually or by using stuffing machines as are known in the art. Examples of such stuffing machines include a vacuum stuffer, Piston driver ham stuffer and an aligned Grain Stuffer (AGS, Harimex Inc., Canada).

In an alternative embodiment, a high volume stuffing process can be used in which the meat pieces are placed in a vacuum stuffer prior to mixing the meat with the cold set binder 32. In particular, a line incorporating a vacuum stuffer, A Fibri-Meat-SysteM™ (Harimex Inc., Canada) and an automatic portioner can be used. Meat pieces are pumped into a device that introduces cold binder solution and mixes the meat pieces with the binder. An automatic portioner (Poly-Clip™, PolyClip Inc.) is placed after the mixer unit to portion the product into casings. A tight ring is clipped around the casing and separates one portion from another.

With Fibrimex™, the time required for bonding depends on a number of parameters, including the ratio of fibrinogen to thrombin and temperature. The parameters for bonding meat products containing fat are the same as those for meat only products. In general, increasing the amount of thrombin relative to fibrinogen reduces the amount of time required for bonding. Temperatures at which thrombin is active and can be used for bonding generally range from about −5° C. to 55° C., and include temperatures at which the meat is tempered. Because thrombin activity increases with increasing temperatures, bonding 38 will be faster at the higher temperatures. The meat product can therefore be cooked immediately after stuffing such that bonding is completed as the temperature of the product increases during cooking. If the meat product is subjected to blast freezing immediately after forming 34, thrombin activity is quickly and significantly reduced and bonding is completed as the product thaws and thrombin activity is increased.

After the meat product is formed, but before it is allowed to bond 38, a natural fat cap 8 may be applied to the surface of the formed product, i.e., the meat core 3. The fat cap 8 is a unitary piece of fat previously removed from a meat cut. Treatments that result in the melting of the fat cap 8 prior to application to the meat core 3 should be avoided. The fat cap 8 is trimmed to a desired thickness, width and length. In contrast with the myosin-based prior art method that requires a consistent layer of meat along one side of the fat cap for bonding the fat cap to meat, the use of a cold set binder in the present invention provides for bonding of a fat surface itself to meat. As such, while it is not necessary to remove all of the meat from the fat cap 8, all of the meat can be removed.

The prepared fat cap 8 can be stored frozen but should be thawed prior to use. The use of frozen fat caps may result in the formation of a layer of condensate between the meat core 3 and the fat cap 8, which interferes with bonding. In addition, the fat cap 8 must be sufficiently pliable so as to conform to the shape of the meat core.

Following completion of the bonding 38, the product may be subsequently processed 40. For example, the product may be sliced to form steaks or other products, frozen, cooked, or aged.

The invention will now be further described by way of the following examples.

### EXAMPLE 1

Powdered fat was produced by trimming excess meat off a beef fat cap removed from the primal seven-bone rib. The fat cap was frozen and then ground using a kidney plate with 1″ holes on a Wetter meat grinder. The ground fat was run through a Sydelmann silent cutter at speed III while adding dry ice pellets until a very fine powder was obtained. Approximately ¾ lbs of dry ice was used per 1 lb. of fat. The fat powder was stored in the freezer until immediately before use.

### EXAMPLE 2

Fresh beef pectoral meat was trimmed of all excessive fat and sinew (trimming loss 6% w/w) and then cut into pieces of approximately 2″×4″×1″. The meat pieces were macerated using a Biro Sir Steak Tenderizer, with a 10 mm cut depth and 8 mm width between the cuts. The meat muscle was passed through the tenderizer once with the grain and once across the grain of the muscle. Immediately after macerating the pectoral pieces were placed in a vacuum tumbler, followed by the addition of a previously prepared marinade solution of the following composition:

| | % of total weight |
|---|---|
| | (meat + marinade) |
| water | 11.4% |
| sodium tri-polyphosphate | 0.4% |
| corn syrup solids | 0.3% |
| NaCl | 0.7% |
| Sodium bicarbonate | 0.2% |
| Powdered fat | 6.0% |

To prepare the marinade, sodium tri-polyphosphate was first dissolved in water. Corn syrup solids, NaCl and sodium bicarbonate were subsequently dissolved in the water phosphate solution. The marinade was cooled to 0° C. and the frozen powdered fat was blended into the marinade with a high-speed blender for approximately 2 minutes to form a homogenous slurry. Immediately after blending, the fat-containing marinade was added to the meat and vacuum tumbled under 0.85 bar vacuum for 10 minutes at 8 RPM.

A Fibrimex™ binder was prepared by thawing the provided solutions of fibrinogen and thrombin for 1½ hrs using running water of 80-85° F., then mixing the solutions in a 10:1 (v/v) ratio of fibrinogen:thrombin. The binder was applied to the surface of to the meat in an amount of 5% w/w based on meat weight. The meat was transferred within 5 minutes to an Aligned Grain Stuffer (AGS, Harimex Inc, Canada). The meat parts were stuffed into perforated casing with 5¼ filled diameter, slack-filed and clipped. The composite was allowed to set for approximately 8 hours at 0° C. to 4° C. in order to obtain a good bonding. The product was removed from the casings and cut into slices of ¾″ that resembled rib-eye steak. The bonding in these slices was sufficiently strong and stable for further processing as a natural whole muscle meat product.

### EXAMPLE 3

Meat was trimmed, macerated, marinated with a marinade containing added fat powder, and mixed with Fibrimex™ binder, as described in Example 2. The meat was weighed into 5 lb portions and then placed in rollstock pouches with dimensions of 5″×7″ with a depth of 3″. A trimmed and sized fat cap was then placed on top of the second meat portion and the entire form was then run through the rollstock machine, vacuum-sealed and placed on racks. The composite was allowed to set for approximately 8 hours at 0° C. to 4° C. in order to obtain a good bonding. The product was then removed from the pouches and cut into slices of ¾″ that resembled a strip loin steak. The bonding in these slices was sufficiently strong and stable for further processing as a natural whole muscle meat product.

### EXAMPLE 4

Fresh beef sirloin trim was run through a Carruthers slicer to obtain 2″×4″×1″ pieces. The meat pieces were run through a Biro Steak Tenderizer, with a 10 mm cut depth and 8 mm width between the cuts, with a single pass in random direction. A Fibrimex™ binder with a ratio of 20:1 (v/v) fibrinogen:thrombin was prepared as described in Example 2. The binder was applied to the surface of the meat in an amount of 5% w/w based on meat weight using a paddle mixer. Five lb portions were placed in pouches on a rollstock packaging machine, with pouch dimensions of 5″×7″ with a depth of 3″. A sized fat cap with dimensions of 5″×7″ and ¼″ thickness was placed on top of the meat and a top film was vacuum-sealed onto each pouch. The formed product was placed on racks and allowed to set for approximately 8 hours at 2° C. The formed meat was then removed from each pouch and the meat was sliced with a band saw into ¾″ thick steaks. The product resembled striploin steak and the steaks were individually packaged for sale.

### EXAMPLE 5

Previously frozen pork trim was trimmed of excessive fat. The trimmed meat and powdered fat in an amount of 6% w/w based on meat weight were added into a vacuum tumbler. The meat was vacuum tumbled under 0.85 bar vacuum for 10 minutes at 8 RPM. The meat was removed from the tumbler, weighed, and placed in a ribbon mixer. A Fibrimex® binder with a ratio of 20:1 (v/v) fibrinogen:thrombin was prepared as described in Example 2. The binder was added to the meat in an amount of 5.5% w/w based on meat weight. The binder was mixed with the meat for 1 minute at low speed. The meat was transferred to a Handtmann vacuum stuffer (VF200), stuffed into 4½″ perforated casings, clipped using a double clipper, placed on racks and directly frozen. The frozen product was cut into 1″ thick steaks using a band saw and the steaks were vacuum packaged.

### EXAMPLE 6

Meat was trimmed and marinated with a marinade containing added fat powder, as described in Example 2. A transglutaminase binder known as Activa™ RM, available from Ajinomoto, Japan was prepared by whisking water and the transglutaminase powder in a 5:1 ratio v/w until the powder was completely dissolved. The binder was applied to the surface of the meat in an amount of 6% v/w based on meat weight by hand. The meat parts were placed into a 12″×8″ and 3″ deep plastic container. A sized fat cap with dimensions of 12″×8″ and ¼″ thickness was placed on top of the meat. A plastic lid was used to close the container, pushing out as much air as possible while closing it. The composite was allowed to set for approximately 14 hours at 0° C. to 4° C. in order to obtain a good bonding. The product was removed from the container and cut into slices of ¾″ that resembles striploin steak. The bonding in these slices was sufficiently strong and stable for further processing as a natural whole muscle meat product.

The embodiments of the invention in which an exclusive property or privilege is claimed are defined as follows:

1. A method for producing a composite meat product comprising the steps of:
a) providing raw meat pieces;
b) mixing powdered fat with the meat pieces to produce a first mixture;
c) mixing a cold set binder with the first mixture to produce a second mixture;
d) forming the second mixture into a desired shape; and
e) maintaining the desired shape at least until adjoining meat pieces and fat become bonded together.

2. The method of claim 1 wherein the cold set binder comprises fibrinogen and thrombin.

3. The method of claim 1 wherein the powdered fat is substantially homogeneously dispersed in an aqueous solution prior to mixing with the meat pieces.

4. The method of claim 3 wherein the aqueous solution is a marinade.

5. The method of claim 1 wherein the step of maintaining is carried out at a temperature of −5° C. to 55° C.

6. The method of claim 1 wherein a) a plurality of cuts have been made in the meat, or b) the meat has been marinated, or both a) and b).

7. The method of claim 6 wherein the cuts have been made by a macerator.

8. The method of claim 6 wherein the powdered fat is distributed within the cuts.

9. The method of claim 1 wherein the meat of is selected from the group consisting of beef, poultry, pork, lamb, fish and seafood.

10. The method of claim 1 wherein the cold set binder is based on transglutaminase.

11. A method for producing a composite meat product comprising the steps of:
a) providing raw meat pieces;
b) producing a plurality of cuts in the meat;
c) mixing powdered fat with the meat pieces to produce a first mixture;
d) mixing a cold set binder with the first mixture to produce a second mixture;
e) forming the second mixture into a desired shape; and
f) maintaining the desired shape at least until adjoining meat pieces and fat become bonded together.

12. The method of claim 11 wherein the cold set binder comprises fibrinogen and thrombin.

13. The method of claim 11 wherein the cuts are made by a macerator.

14. The method of claim 11 wherein the powdered fat is distributed within the cuts

15. The method of claim 11 wherein the powdered fat is substantially homogeneously dispersed in an aqueous solution prior to mixing with the meat pieces.

16. The method of claim 15 wherein the aqueous solution is a marinade.

17. The method of claim 11 wherein the step of maintaining is carried out at a temperature of −5° C. to 55° C.

18. The method of claim 11 wherein the meat of is selected from the group consisting of beef, poultry, pork, lamb, fish and seafood.

19. The method of claim 14 wherein the cold set binder is based on transglutaminase.

20. A method for producing a composite meat product comprising the steps of:
a) providing raw meat pieces;
b) mixing powdered fat with the meat pieces to produce a first mixture;
c) mixing a cold set binder with the first mixture to produce a second mixture;
d) forming the second mixture into a desired shape;
e) placing at least one unitary piece of fat on the surface of the formed mixture; and
f) maintaining the desired shape of the mixture and placement of the fat piece until adjoining meat pieces and fat become bonded together.

21. The method of claim 20 wherein the cold set binder comprises fibrinogen and thrombin.

22. The method of claim 20 wherein the powdered fat is substantially homogeneously dispersed in an aqueous solution prior to mixing with the meat pieces.

23. The method of claim 22 wherein the aqueous solution is a marinade.

24. The method of claim 20 wherein the step of maintaining is carried out at a temperature of −5° C. to 55° C.

25. The method of claim 20 wherein a) a plurality of cuts have been made in the meat, or b) the meat has been marinated, or both a) and b).

26. The method of claim 25 wherein the cuts have been made by a macerator.

27. The method of claim 20 wherein the meat of is selected from the group consisting of beef, poultry, pork, lamb, fish and seafood.

28. The method of claim 20 wherein the cold set binder is based on transglutaminase.

29. A method for producing a composite meat product comprising the steps of:
a) providing raw meat pieces;
b) producing a plurality of cuts in the meat pieces;
c) mixing powdered fat with the meat pieces to produce a first mixture;
d) mixing a cold set binder with the first mixture to produce a second mixture;
e) forming the second mixture into a desired shape;
f) placing at least one unitary piece of fat on the surface of the formed mixture; and
g) maintaining the desired shape of the mixture and placement of the fat piece at least until adjoining meat pieces and fat become bonded together.

30. The method of claim 29 wherein the cold set binder comprises fibrinogen and thrombin.

31. The method of claim 29 wherein the cuts have been made by a macerator.

32. The method of claim 31 wherein the powdered fat is substantially homogeneously dispersed in an aqueous solution prior to mixing with the meat pieces.

33. The method of claim 32 wherein the aqueous solution is a marinade.

34. The method of claim 29 wherein the step of maintaining is carried out at a temperature of −5° C. to 55° C.

35. The method of claim 29 wherein the meat of is selected from the group consisting of beef, poultry, pork, lamb, fish and seafood

36. The method of claim 29 wherein the cold set binder is based on transglutaminase.

37. A composite meat product comprising a meat portion and a fat portion formed of powdered fat wherein adjoining meat and fat portions are bonded together with a cold set binder.

38. The product of claim 37 wherein the product is any of raw, frozen, or cooked.
